(19) United States
(12) Patent Application Publication
(10) Pub. No.: US 2026/0116368 A1
(43) Pub. Date: Apr. 30, 2026

(54) SYSTEM AND METHOD FOR CONTROLLING A VEHICLE USING A MODEL PREDICTIVE CONTROLLER AND A BAYESIAN META-LEARNING MODEL

(71) Applicant: Toyota Research Institute, Inc., Los Altos, CA (US)

(72) Inventors: Alexander Davydov, Santa Barbara, CA (US); Franck Djeumou, Troy, NY (US); Carl M. Greiff, Mountain View, CA (US); Makoto Suminaka, Mountain View, CA (US); Michael Thompson, San Juan Capistrano, CA (US); John K. Subosits, Mountain View, CA (US); Thomas J. Lew, Palo Alto, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/244,246

(22) Filed: Jun. 20, 2025

Related U.S. Application Data
(60) Provisional application No. 63/711,796, filed on Oct. 25, 2024.

(51) Int. Cl. B60W 20/11; B60W 50/00; G06N 3/08

(52) U.S. Cl. CPC B60W 20/11; B60W 50/0097; G06N 3/08

(57) ABSTRACT

Disclosed are systems and methods for vehicle control. In one example, the system includes a memory with an instruction module that, when executed by a processor, directs the processor to manage vehicle operation using a control action sequence from a model predictive controller. This controller utilizes an enhanced predicted vehicle state derived from a predicted vehicle state and a residual generated by a last-layer Bayesian meta-learning vehicle model. The system enhances vehicle control by integrating advanced predictive modeling and adaptive learning techniques.

### CROSS-REFERENCE TO RELATED APPLICATION

This application claims priority to U.S. Provisional Patent Application 63/711,796 filed Oct. 25, 2024, the contents of which is hereby incorporated by reference in its entirety.

### TECHNICAL FIELD

The subject matter described herein relates, in general, to vehicle control systems and, more specifically, to utilizing model predictive controllers and Bayesian meta-learning models for controlling vehicles to enhance driving performance in dynamic and unstable maneuvers.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Autonomous and semi-autonomous vehicle systems may rely on data-driven models to predict vehicle behavior and plan control actions. Model Predictive Control (MPC) is a widely used framework in these systems due to its ability to plan future control inputs over a defined horizon while explicitly considering system dynamics and constraints. Traditional MPC frameworks often rely on physics-based vehicle dynamics models to make forward predictions; however, these models can suffer from inaccuracies due to unmodeled dynamics, changes in operating conditions (e.g., road surface, tire wear), or system variability. These inaccuracies can lead to degraded control performance, particularly in high-speed or unstable driving scenarios, where precise modeling is essential.

To address these limitations, adaptive modeling techniques have been introduced, including neural network-based residual models that correct prediction errors. While effective in some cases, these models often require large amounts of data and may not adapt quickly enough to ensure safe and reliable control in real time. Recently, meta-learning techniques—particularly last-layer Bayesian meta-learning—have shown promise in enabling fast adaptation by learning expressive feature representations and updating only a small set of last-layer parameters. When combined with model predictive control, such an approach allows the system to correct model errors dynamically and maintain accurate vehicle state predictions under uncertain or rapidly changing conditions. However, there remains a need for an integrated system that efficiently fuses model-based predictions with Bayesian adaptive corrections to enhance control performance in practical deployment of such methods for driving applications.

### SUMMARY

This section generally summarizes the disclosure and is not a comprehensive explanation of its full scope or all its features.

In one embodiment, a system may include a memory having an instruction module with instructions that, when executed by a processor, cause the processor to control a vehicle using a control action sequence generated by a model predictive controller. The model predictive controller utilizes an enhanced predicted vehicle state derived from a predicted vehicle state and a residual produced by a last-layer Bayesian meta-learning model.

In another embodiment, a method includes controlling a vehicle using a control action sequence generated by a model predictive controller that bases its operation on an enhanced predicted vehicle state obtained from a dynamics model prediction and a residual from a last-layer Bayesian meta-learning model.

In yet another embodiment, a non-transitory computer-readable medium stores instructions that, when executed by a processor, cause the processor to control a vehicle using a control action sequence produced by a model predictive controller. The controller's operation is based on an enhanced predicted vehicle state, which is derived from a predicted vehicle state and a residual obtained from a last-layer Bayesian meta-learning model.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates a block diagram of the integration of a last-layer Bayesian meta-learning model and a physics-based vehicle dynamics model within an MPC framework.

FIG. 2 illustrates a schematic block diagram of a vehicle incorporating a vehicle control system that uses the last-layer Bayesian meta-learning model and a vehicle dynamics model within an MPC framework.

FIG. 3 illustrates a block diagram of the architecture of a vehicle control system integrating MPC and last-layer Bayesian meta-learning for dynamic vehicle maneuvers.

FIG. 4 illustrates a flow chart diagram of a method for controlling a vehicle using an MPC and Bayesian meta-learning model.

FIG. 5 illustrates a block diagram of the process flow of training and adapting the last-layer Bayesian meta-learning vehicle model.

### DETAILED DESCRIPTION

Described herein are systems and methods related to controlling a vehicle using a model predictive controller (MPC) integrated with a last-layer Bayesian meta-learning model to enhance vehicle control performance, particularly in dynamic and unstable driving maneuvers. The systems and methods described herein use an MPC integrated with a last-layer Bayesian meta-learning model to enhance vehicle control performance, particularly in dynamic and unstable driving maneuvers. Moreover, the last-layer Bayesian meta-learning model generates a residual, which is a corrective term to account for discrepancies between the predicted vehicle state derived by the vehicle dynamics model and the actual vehicle behavior. The MPC processes this combined information, along with other inputs such as the current vehicle state, reference trajectory, and constraints, to generate a control action sequence. This sequence of control inputs is designed to guide the vehicle along the desired trajectory while adhering to operational constraints, such as actuator limits and obstacle avoidance. The control action sequence is then applied to the vehicle's actuators, effectively managing its movement and ensuring optimal performance and stability, even in challenging driving scenarios.

In addition, the last-layer Bayesian meta-learning model may be trained offline and/or online. Offline training could include a stage wherein the last-layer Bayesian meta-learning model learns a shared neural feature extractor and a prior distribution over its last-layer weights using a diverse set of driving trajectories. This enables the model to rapidly adapt to new dynamics using Bayesian updates with minimal data. Additionally or alternatively, in another offline training stage, the last-layer Bayesian meta-learning model could be refined offline using actively gathered, information-rich trajectories generated by an information-theoretic MPC formulation (Info-OCP). These targeted trajectories expose the last-layer Bayesian meta-learning model to uncertain or underexplored regions of the state space, allowing it to specialize before being used in high-performance control tasks like drifting. Finally, during online training, the last-layer Bayesian meta-learning model may continue to update its last-layer parameters in real-time using incoming vehicle data, ensuring it remains accurate and responsive to dynamic changes such as tire wear or shifting road conditions.

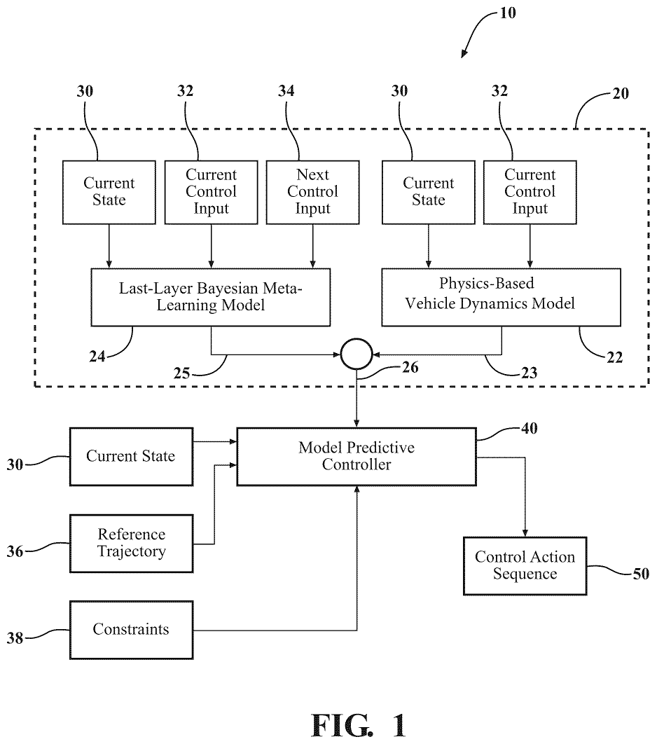

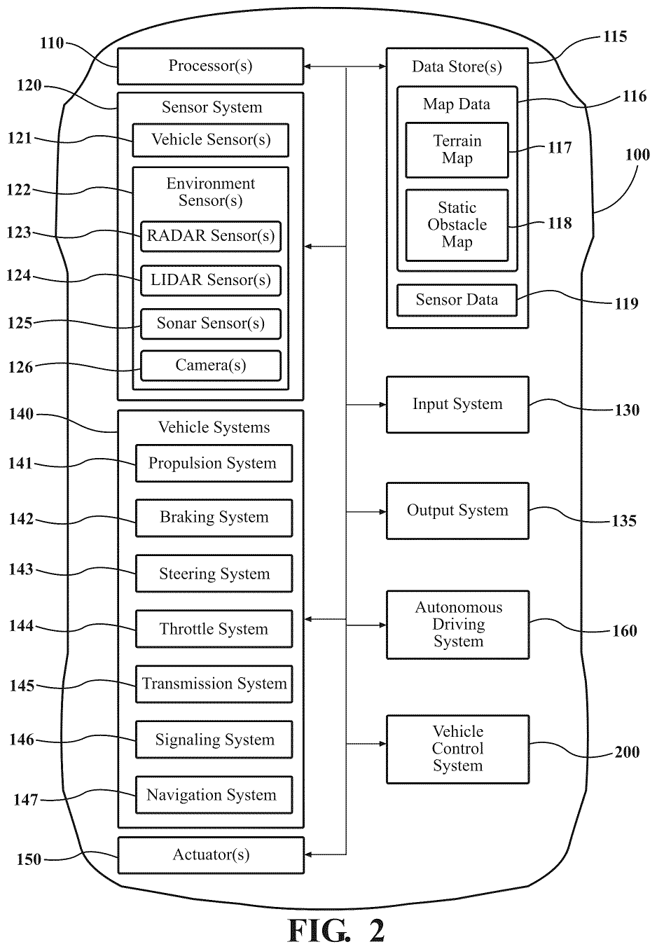

Referring to FIG. 1 illustrated is one example of a process flow 10 for a system and method for controlling a vehicle 100 (shown in FIG. 2) using an MPC 40 integrated with a framework for generating an enhanced predicted vehicle state 26. In one example, the framework includes a vehicle dynamics model 22 and a last-layer Bayesian meta-learning model 24, acting as an overall model 20. The vehicle dynamics model 22 generates a predicted next vehicle state 23 (h(xₖ, uₖ)) that describes a future state of the vehicle 100 based on a current state 30 (xₖ) and current control inputs 32 (uₖ). It typically employs a physics-based approach, such as a bicycle model, to simulate the vehicle's behavior under various conditions.

The current state 30 (xₖ) may include parameters that describe the vehicle's present condition and position and may include variables such as yaw rate (r), total velocity (v), sideslip (β), rear wheelspeed (ωᵣ), and lateral and angle deviations (e and Δφ) to a reference trajectory. The current control input 32 may include steering angle (δ) and engine torque (τ). As such, states and control inputs of the vehicle 100 can be expressed as:

$$x = ( r , v , β , {ω}_{r} , e , Δφ ) ∈ {ℝ}^{n} , u = ( δ , τ ) ∈ {ℝ}^{m} . \qquad ( 1 )$$

The vehicle is modeled with discrete-time dynamics as:

$${x}_{k + 1} = {f}_{ξ} ( {x}_{k} , {\tilde{u}}_{k} ) + {ϵ}_{k} , \qquad ( 2 )$$

where

$$k ∈ ℕ and {ϵ}_{k} ∼ 𝒩 ( 0 , diag ( {σ}_{1}^{2} , ... , {σ}_{n}^{2} ) )$$

are Gaussian distributed disturbances that are independent over time k and state dimensions, i. ξ represent unknown parameters of the dynamics (e.g., corresponding to unmodeled phenomena) and ũₖ=(uₖ, \dot{u}ₖ) includes the control input rate \dot{u}ₖ=(\dot{δ}ₖ, \dot{τ}ₖ) at time k. Including \dot{u}ₖ in ũₖ and Equation (2) accounts for the fact that the MPC 40 plans (u0, u1, . . . , uN) are executed by a low-level controller via linear interpolation on the control horizon. That is, u(kΔt+τ)=uₖ+τ\dot{u}ₖ with Δt=0.1 s and \dot{u}ₖ=(uₖ₊₁−uₖ)/Δt for τ∈[0, Δt).

The last-layer Bayesian meta-learning model 24 predicts a residual 25 (g_{θ}) between the true vehicle dynamics and the predicted vehicle state 23 output by the vehicle dynamics model 22. The input (zₖ) to the last-layer Bayesian meta-learning model 24 includes the current state 30 and the current control input 32, which were previously described, as well as a next control input 34 (uₖ₊₁=(δₖ₊₁, τₖ₊₁)), which includes the next steering and next torque inputs.

The last-layer Bayesian meta-learning model 24 can take a number of different forms. In one example, the last-layer Bayesian meta-learning model 24 combines expressive neural network features with a probabilistic representation of the last layer of the last-layer Bayesian meta-learning model 24. The earlier layers of the last-layer Bayesian meta-learning model 24 extract high-level features from the input data, while the last layer is modeled using Bayesian linear regression. This structure allows the model to capture uncertainty in its predictions and rapidly adapt the final layer weights using new data without retraining the entire network. As a result, the model 24 supports fast and efficient updates during both offline adaptation and online deployment. As mentioned, the last-layer Bayesian meta-learning model 24 can take a number of different forms. The chart below illustrates an example of one form the last-layer Bayesian meta-learning model 24 may take.

| | | | Activation | Description / Notes |
|---|---|---|---|---|
| Layer | Type | Size/Shape | Function | |
| Input Layer | Input | 8 | — | Inputs: rₖ, vₖ, βₖ, ω_{r,k}, δₖ, τₖ, δₖ₊₁, τₖ₊₁ |
| Hidden Layer 1 | Dense | 128 × 8 | tanh | First nonlinear transformation |
| Hidden Layer 2 | Dense | 128 × 128 | tanh | Deeper representation of features |
| Output Projection | Dense | 4 × 16 × 128 | Linear | Compresses to 16D learned feature |
| | | | | vector φᵢ(zₖ) |
| Bayesian Last Layer | Linear (Bayesian) | 4 × 16 | Linear (Bayesian) | ${g}_{i} ( {z}_{k} ) = {θ}_{i}^{T} {ϕ}_{i} ( {z}_{k} ) , where {θ}_{i} \sim 𝒩 ( {\overline{θ}}_{i} , {σ}^{2} {Λ}_{i}^{- 1} )$ |

The enhanced predicted vehicle state 26 is approximated using the model:

$${x}_{k + 1} = h ( {x}_{k} , {u}_{k} ) + {g}_{θ} ( {z}_{k} ) + {ϵ}_{k} , \qquad ( 3 )$$

where h: [symbol] ⁿ× [symbol] ^{m}→ [symbol] ⁿ given by Euler integration of a standard bicycle model, and the residual 25 (g_{θ}) is modeled by g_{θ}(z)=(g₁, . . . , gₙ)(z) with inputs

$${z}_{k} = ( ( {r}_{k} , {v}_{k} , {β}_{k} , {ω}_{r , k} ) , {u}_{k} , {u}_{k + 1} ) ,$$

and each dimension i of g_{θ}(⋅) is linear over learned features φᵢ(z)∈ [symbol] ^{d} for some parameters θᵢ∈ [symbol] ^{d}, that is

$${g}_{i} ( {z}_{k} ) := {θ}_{i}^{T} {ϕ}_{i} ( {z}_{k} ) , i ∈ \{ 1 , ... , n \} . \qquad ( 4 )$$

In this example, the variables e and Δφ may be omitted since they do not affect the dynamics of any of the other state variables and their dynamics can be explicitly computed from geometry. As such, given the state in Equation (1), g₅=g₆=0.

The features φᵢ(⋅) are neural networks that are learned jointly with the parameters θ via last-layer Bayesian meta-learning model 24 to yield an expressive model capable of rapid adaptation with uncertainty estimates. Specifically, viewing gᵢ(zₖ) as a neural network, the last-layer parameter θᵢ is parameterized using a Gaussian distribution

$${θ}_{i} ∼ 𝒩 ( {\overline{θ}}_{i} , {σ}_{i}^{2} {Λ}_{i}^{- 1} ) , i ∈ \{ 1 , ... , n \} , \qquad ( 5 )$$

with mean parameters θ̅ᵢ and positive definite precision matrices Λᵢ. Independent Gaussian distributions of each θi are modeled such that the last layer parameters (θ₁, . . . , θₙ) are Gaussian.

The linear structure of gᵢ(z) enables the computation of the last-layer parameters of the θᵢ of the last-layer Bayesian meta-learning model 24 via Bayesian linear regression. Specifically, given prior distributions

$$𝒩 ( {\overline{θ}}_{i , 0} , {σ}_{i}^{2} {Λ}_{i , 0}^{- 1} )$$

for θᵢ, and a state-control trajectory

$${𝒟}_{T} = {\{ ( {z}_{k} , {x}_{k + 1} ) \}}_{k = 0}^{T} ,$$

the posterior θ_{i,T}| [symbol] _{T} is Gaussian and can be computed recursively from Q_{i,0}=Λ_{i,0}θ̅_{i,0} by

$${Λ}_{i , k + 1}^{- 1} = {Λ}_{i , k}^{- 1} - \frac{( {Λ}_{i , k}^{- 1} {ϕ}_{i} ( {z}_{k} ) ) {( {Λ}_{i , k}^{- 1} {ϕ}_{i} ( {z}_{k} ) )}^{⊤}}{1 + {{ϕ}_{i} ( {z}_{k} )}^{⊤} {Λ}_{i , k}^{- 1} {ϕ}_{i} ( {z}_{k} )} , \qquad ( 6 a )$$

$${Q}_{i , k + 1} = {Q}_{i , k} + ( {x}_{i , k + 1} - {h}_{i} ( {x}_{k} , {u}_{k} ) ) {ϕ}_{i} ( {z}_{k} ) , \qquad ( 6 b )$$

$${\overline{θ}}_{i , k + 1} = {Λ}_{i , k + 1}^{- 1} {Q}_{i , k + 1} . \qquad ( 6 c )$$

Moreover, the one-step predictions are Gaussian-distributed, that is, x_{i,k+1}|x_{0:k}, ũ_{0:k}˜ [symbol] (μ_{i,k+1}, Σ_{i,k+1}) with

$${μ}_{i , k + 1} = {h}_{i} ( {x}_{k} , {u}_{k} ) + {\overline{θ}}_{i , k}^{⊤} {ϕ}_{i} ( {z}_{k} ) , \qquad ( 7 a )$$

$${\sum }_{i , k + 1} = {σ}_{i}^{2} ( 1 + {{ϕ}_{i} ( {z}_{k} )}^{⊤} {Λ}_{i , k}^{- 1} {ϕ}_{i} ( {z}_{k} ) ) . \qquad ( 7 b )$$

With the last-layer Bayesian meta-learning model 24, the mismatch between the true dynamics f and the nominal model h through g_{θ} is learned such that the one-step-ahead predictions are Gaussian by design, facilitating both meta-learning and information gathering.

Once the enhanced predicted vehicle state is determined, the MPC 40 determines a control action sequence 50 using the enhanced predicted vehicle state 26, the current state 30, reference trajectories 36, and constraints 38. Specifically, the MPC 40 uses the enhanced model to simulate how the vehicle 100 would respond to various candidate control inputs over a future prediction horizon. It then formulates and solves an optimization problem to select the sequence of control actions that minimizes a cost function, which penalizes deviation from the reference trajectory 36, large changes in control inputs, and any violation of operational constraints 38, such as steering and torque limits or staying within track boundaries. Although MPC 40 determines the entire control action sequence 50 over the horizon, only the first control input is applied to the vehicle. At the next control cycle, the process is repeated using updated state information, allowing MPC 40 to continuously refine its decisions in real-time for accurate and stable vehicle control.

As mentioned before, the last-layer Bayesian meta-learning model 24 may be trained using offline and online training. Offline training process may include two stages. In the first stage, a vehicle dynamics model is meta-trained using a dataset of prior driving trajectories. This enables learning expressive neural network features through the shared layers by using data from multiple trajectories that represent variations in the dynamics of an underlying system.

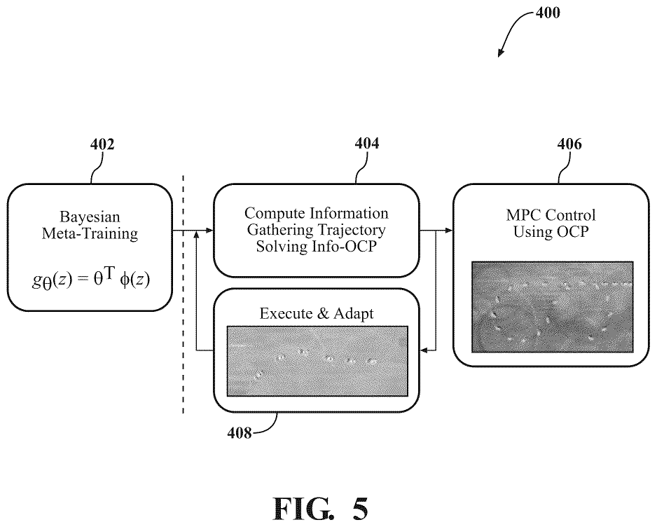

In the second offline training stage, the last-layer Bayesian meta-learning model 24 may learn prior distributions over the last-layer weights of the last-layer by simulating a process of online Bayesian linear regression across a collection of training trajectories that represent different system dynamics. As to online training, online training updates the last layer of the last-layer Bayesian meta-learning model 24 during deployment using new data. Additional details regarding online and offline training will be provided later in this description, especially when describing FIG. 5.

Referring to FIG. 2, the process flow 10 of FIG. 1 may be performed by a vehicle control system 200, which is mounted within the vehicle 100. As used herein, a “vehicle” is any form of powered transport. In one or more implementations, the vehicle 100 is an automobile. While not required, in some cases, the vehicle 100 may include an autonomous driving system 160. The automated/autonomous systems or combination of systems may vary in various embodiments. For example, in one aspect, the automated system is a system that provides autonomous control of the vehicle according to one or more levels of automation, such as the levels defined by the Society of Automotive Engineers (SAE) (e.g., levels 0-5). As such, the autonomous system may provide semi-autonomous control or fully autonomous control, as discussed in relation to the autonomous driving system 160.

The vehicle 100 also includes various elements. It will be understood that in various embodiments, it may not be necessary for the vehicle 100 to have all of the elements shown in FIG. 2. The vehicle 100 can have any combination of the various elements shown in FIG. 2. Further, the vehicle 100 can have additional elements to those shown in FIG. 2. In some arrangements, the vehicle 100 may be implemented without one or more of the elements shown in FIG. 2. While the various elements are shown as being located within the vehicle 100 in FIG. 2, it will be understood that one or more of these elements can be located external to the vehicle 100. Further, the elements shown may be physically separated by large distances and provided as remote services (e.g., cloud-computing services).

Some of the possible elements of the vehicle 100 are shown in FIG. 2 and will be described along with subsequent figures. However, a description of many of the elements in FIG. 2 will be provided after the discussion of the figures for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

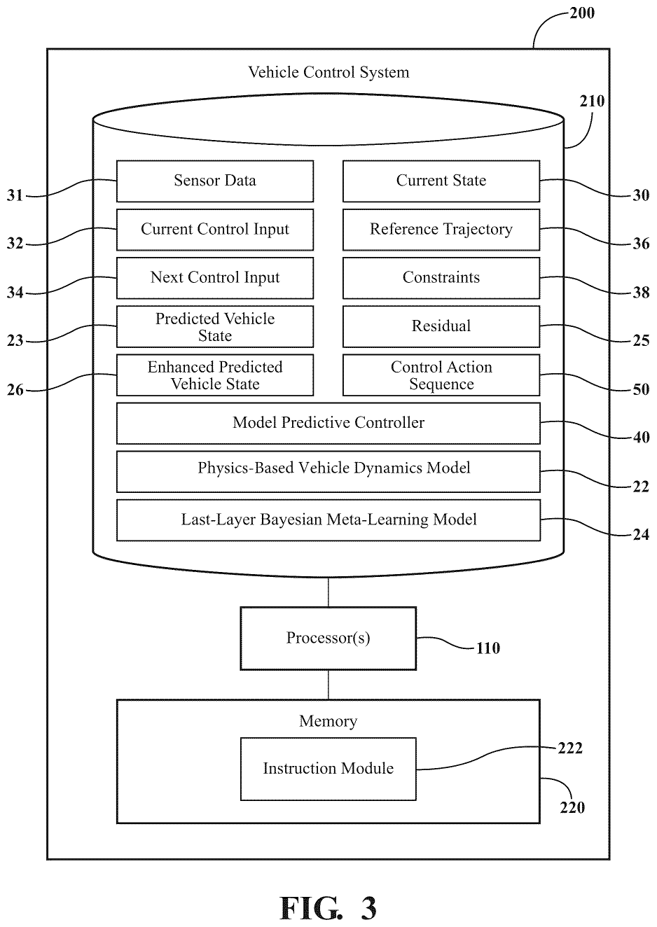

In either case, as mentioned before, the vehicle 100 includes a vehicle control system 200. The vehicle control system 200 may be incorporated within an autonomous driving system 160 or may be separate, as shown. With reference to FIG. 3, one embodiment of the vehicle control system 200 is further illustrated. As shown, the vehicle control system 200 includes a processor(s) 110. Accordingly, the processor(s) 110 may be a part of the vehicle control system 200, or the vehicle control system 200 may access the processor(s) 110 through a data bus or another communication path. For example, the processor(s) 110 may be one or more processor(s) 110 found within the vehicle 100.

In one or more embodiments, the processor(s) 110 is an application-specific integrated circuit that is configured to implement functions associated with an instruction module 222. In general, the processor(s) 110 is an electronic processor, such as a microprocessor, capable of performing various functions described herein. In one embodiment, the vehicle control system 200 includes a memory 220 that stores the instruction module 222. The memory 220 is a random-access memory (RAM), read-only memory (ROM), a hard disk drive, flash memory, or other suitable memory for storing the instruction module 222. The instruction module 222 is, for example, computer-readable instructions that, when executed by the processor(s) 110, cause the processor(s) 110 to perform the various functions disclosed herein.

Furthermore, in one embodiment, the vehicle control system 200 includes data store(s) 210. The data store(s) 210 is, in one embodiment, an electronic data structure such as a database that is stored in the memory 220 or another memory and that is configured with routines that can be executed by the processor(s) 110 for analyzing stored data, providing stored data, organizing stored data, and so on. Thus, in one embodiment, the data store(s) 210 stores data used by the instruction module 222 in executing various functions.

In one embodiment, the data store(s) 210 includes several elements that were previously described, such as the current state 30, the current control input 32, the reference trajectory 36, the next control input 34, the constraints 38, the predicted next vehicle state 23, the residual 25, the enhanced predicted vehicle state 26, the control action sequence 50, the MPC 40, the vehicle dynamics model 22, and the last-layer Bayesian meta-learning model 24. In addition, the data store(s) 210 may include information collected from the sensor system 120 that can indicate yaw rate, vehicle speed, sideslip angle, rear wheel speed, steering angle, engine torque, and position and orientation.

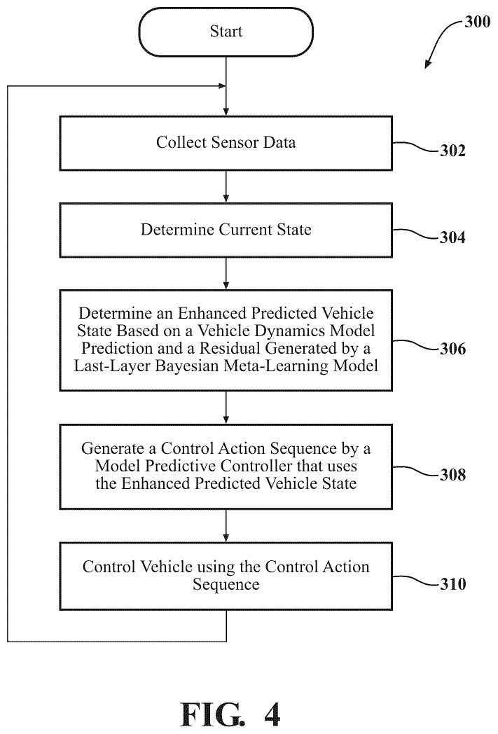

Accordingly, the instruction module 222 generally includes instructions that control the processor(s) 110 to perform any of the methodologies disclosed herein, such as the method 300 illustrated in FIG. 4. As such, the method 300 will be described from the viewpoint of the vehicle 100 of FIG. 2 and the vehicle control system 200 of FIG. 4. However, it should be understood that this is just one example of implementing the method 300. While method 300 is discussed in combination with the vehicle control system 200, it should be appreciated that the method 300 is not limited to being implemented within the vehicle control system 200, but is instead one example of a system that may implement the method 300.

In step 302, the instructions within the instruction module 222, when executed by the processor(s) 110, cause the processor(s) 110 to collect sensor data 31 from the sensor system 120 of the vehicle 100. As explained previously, this data can include information such as yaw rate, velocity, sideslip angle, rear wheel speed, steering angle, engine torque, and position/orientation information.

In step 304, the instructions within the instruction module 222, when executed by the processor(s) 110, cause the processor(s) 110 to determine the current state 30 using the sensor data 31. As explained before, the current state 30 includes the relevant vehicle dynamics variables required for control, such as velocity, yaw rate, and slip angle.

In step 306, the instructions within the instruction module 222, when executed by the processor(s) 110, cause the processor(s) 110 to determine the enhanced predicted vehicle state 26. As explained previously, the enhanced predicted vehicle state 26 combines the predicted next vehicle state 23 output by the vehicle dynamics model 22 with a residual 25 generated by the last-layer Bayesian meta-learning model 24. As described previously, the residual 25 is generated by the last-layer Bayesian meta-learning model 24 that applies expressive neural network features and Bayesian linear regression on the last layer to capture uncertainty and enable fast adaptation. As such, the enhanced predicted vehicle state 26 provides a more accurate estimate of the vehicle's future states.

In step 308, the instructions within the instruction module 222, when executed by the processor(s) 110, cause the processor(s) 110 to generate the control action sequence 50 (control inputs such as steering angle and engine torque) by solving an optimization problem that uses the enhanced predicted vehicle state 26, the current state 30, reference trajectories 36, and constraints 38. The MPC 40 minimizes a cost function that penalizes deviation from the desired path and excessive control effort while ensuring safe vehicle operation.

In step 310, the instructions within the instruction module 222, when executed by the processor(s) 110, cause the processor(s) 110 to control the vehicle 100 using the control action sequence 50. Moreover, this may involve using the control action sequence 50 to instruct one or more actuator(s) 150 to control one or more vehicle systems 140, such as the steering system 143, the throttle system 144, the braking system 142, and/or other systems making up the vehicle systems 140 of FIG. 2. Thereafter, the method 300 is repeated at each control cycle using updated sensor data, enabling real-time feedback and robust control performance, particularly in dynamic or unstable maneuvers such as drifting.

As mentioned, the last-layer Bayesian meta-learning model 24 may be trained using offline and/or online training techniques. Moreover, FIG. 5 illustrates a process flow 400 that may be utilized to train the last-layer Bayesian meta-learning model 24.

In one example, the offline training of the last-layer Bayesian meta-learning model 24 may be broken into two separate stages. It should be understood that it is not necessary to utilize both offline training stages. In some examples, only one of the offline training stages is utilized. Of course, both could also be utilized.

In one of the offline training stages, indicated in block 402 of FIG. 5, the last-layer Bayesian meta-learning model 24 is meta-trained using a dataset of previously recorded vehicle trajectories. During meta-training, the system receives multiple state-control trajectories, each corresponding to distinct instances of vehicle behavior under varying conditions. The feature extractor is trained to produce expressive latent representations of the vehicle's dynamic response, while the weights of the last-layer Bayesian meta-learning model 24 are modeled as independent multivariate Gaussian distributions, each defined by a learned mean vector and a precision (inverse covariance) matrix.

The training process optimizes the parameters of the feature extractor, the prior means and precisions of the Bayesian last-layer weights, and the observation noise covariances by minimizing a negative log-likelihood objective over one-step-ahead state predictions using the last-layer parameters obtained via maximum likelihood estimation on previous timesteps in the dataset. The loss function accounts for both prediction accuracy and calibrated uncertainty by incorporating the Mahalanobis distance between predicted and actual next states, as well as the log determinant of the predicted covariance matrix, using the Bayesian last-layer weights obtained via maximum likelihood estimation on previous timesteps in the dataset.

This stage of training enables the resulting model to perform rapid online or offline adaptation using computationally efficient Bayesian updates of the last layer parameters. The meta-trained model captures structured uncertainty and is optimized to allow for data-efficient refinement of the last-layer parameters when exposed to new vehicle dynamics during subsequent adaptation or deployment.

Moreover, during offline training, the prior parameters

$$( {\overline{θ}}_{i , 0} , {Λ}_{i , 0}^{- 1} ) ,$$

features φᵢ, and noise covariances

$${σ}_{i}^{2} ,$$

are pretrained offline to obtain an expressive model that can be adapted online using the update rule of Equation (6). Specifically, given a dataset of J trajectories corresponding to different parameters ξ of the true system of Equation (2) and a meta-training horizon T, the negative posterior log-likelihood objective is minimized:

$${ℒ}_{nll} ( \overline{θ} , Λ , ϕ , σ ) = {\sum }_{j = 1}^{J} {\sum }_{k = 1}^{T} {‖ {x}_{k}^{j} - {μ}_{k}^{j} ‖}_{{( {\sum }_{k}^{j} )}^{- 1}}^{2} + log ( det ( {\sum }_{k}^{j} ) ) ,$$

where

$${‖ y ‖}_{A}^{2} = {y}^{⊤} Ay and ( {μ}_{k}^{j} , {\sum }_{k}^{j} )$$

denotes the one-step-ahead prediction computed by Equation (6) at a time k−1 in dataset j. The fact that the posterior parameters are obtained via the update rule is useful for learning expressive features φ that favor rapid online adaptation of the model.

In the second offline learning stage, shown in blocks 404 and 406 of FIG. 5, the last-layer Bayesian meta-learning model 24 is refined using targeted data collected through an active information-gathering process. Specifically, an information-aware MPC routine, referred to as Info-OCP (optimal control problem), is used to generate vehicle trajectories that are designed to maximize the information gain with respect to uncertain or unmodeled aspects of the vehicle dynamics. These trajectories are executed in a controlled offline environment such as a skidpad, and sensor data 31 collected during execution is used to update the posterior distribution of the last-layer parameters of the Bayesian residual model.

The adaptation is performed using Bayesian linear regression update rules applied to the last layer of the last-layer Bayesian meta-learning model 24, allowing the model to incorporate the newly gathered data without retraining the neural network feature extractor. This results in a refined vehicle dynamics model with reduced prediction uncertainty and improved task-specific accuracy, enabling robust downstream control performance. This second stage remains an offline process, completed prior to real-time deployment of the last-layer Bayesian meta-learning model 24 for vehicle control.

Moreover, an MPC formulation that enables tracking dynamic trajectories such as drifting maneuvers parameterized is defined by a reference trajectory x_{ref}. To favor smooth control inputs, fast changes are penalized in the control inputs and define

$${ℓ}_{k} ( x , u , w ) = {‖ x - {x}_{ref , k} ‖}_{Q}^{2} + {‖ u - w ‖}_{R}^{2} ,$$

where (Q, R) are positive semidefinite diagonal matrices. Constraints are imposed to ensure that the vehicle 100 remains on a track, and that actuator(s) 150 operates within hardware constraints. To plan over a horizon N from an initial state xᵢₙᵢₜ, OCP may be formulated as

$${min}_{x , u} {\sum }_{k = 0}^{N - 1} {ℓ}_{k} ( {x}_{k} , {u}_{k} , {u}_{k + 1} ) OCP \qquad ( 8 a )$$

$$s . t . {x}_{k + 1} = {f}_{\overline{θ}} ( {x}_{k} , {u}_{k} , {u}_{k + 1} ) , k ∈ \{ 0 , … , N - 1 \} , \qquad ( 8 b )$$

$${x}_{0} = {x}_{i nit} , \qquad ( 8 c )$$

$${u}_{min} \leq {u}_{k} \leq {u}_{max} , k ∈ \{ 1 , … , N \} , \qquad ( 8 d )$$

$${e}_{min , k} \leq {e}_{k} \leq {e}_{max , k} , k ∈ \{ 1 , … , N \} . \qquad ( 8 e )$$

The quality of solutions to the OCP depends on the accuracy of the model f_{θ̅} parameterized by the last-layer parameters θ̅:

$${f}_{\overline{θ}} ( {x}_{k} , {u}_{k} , {u}_{k + 1} ) = h ( {x}_{k} , {u}_{k} ) + {g}_{\overline{θ}} ( {z}_{k} ) ,$$

where

$${g}_{i} ( {z}_{k} ) = {\overline{θ}}_{i}^{⊤} {ϕ}_{i} ( {z}_{k} )$$

for each i=1, . . . , n.

Directly deploying an MPC 40 that recursively solves OCP using the prior model parameters θ̅_{i,0} after offline meta-training (the first offline training stage previously described) may lead to unsatisfactory performance. As such, an active data collection approach may refine the last-layer Bayesian meta-learning model 24 prior to deployment in challenging applications. Since data collection on the vehicle 100 may be time-consuming and expensive, this raises the question of what data should be collected to best identify the unknown dynamics.

Learning the last-layer Bayesian meta-learning model 24 parameters as quickly as possible amounts to maximizing the information gained from future observations, i.e., maximizing the mutual information between observations and the true system. As such, the information-gathering objective may be defined as:

$${ℓ}_{info} ( x , u ) := \frac{1}{2} {\sum }_{k = 0}^{N - 1} {\sum }_{i = 1}^{n} log ( 1 + {ϕ}_{i , k}^{⊤} {Λ}_{i , 0}^{- 1} {ϕ}_{i , k} ) , \qquad ( 9 )$$

where φ_{i,k}:=φᵢ(xₖ, uₖ, uₖ₊₁). Using [symbol] _{info}, the information gathering optimal control problem may be defined as:

$${min}_{x , u} - {αℓ}_{info} ( x , u ) + {\sum }_{k = 0}^{N - 1} {ℓ}_{k} ( {x}_{k} , {u}_{k} , {u}_{k + 1} ) Info - OCP \qquad ( 10 )$$

$$s . t . ( 8 b ) - ( 8 e ) ,$$

where α>0 weighs the information gain compared to the nominal MPC objective. The nominal cost [symbol] encourages smooth control inputs and the constraints of Equation (8b)-(8e) ensure that the vehicle 100 remains on the track during data collection.

The information-gathering objective in Equation (9) is derived by leveraging the last-layer uncertainty representation of the last-layer Bayesian meta-learning model 24, which yields a closed-form expression of the one-step mutual information between an observation and the dynamics. Moreover, [symbol] _{info} is an approximation of the true total information gain over a trajectory, which may not be exactly the sum of the expected information gains per timestep. Incorporating the linear regression updates in Equation (6) in the objective (by defining the cost

$${\tilde{ℓ}}_{infi} = \frac{1}{2} {\sum }_{k = 0}^{N - 1} {\sum }_{i = 1}^{n} log ( 1 + {ϕ}_{i , k}^{T} {Λ}_{i , k}^{- 1} {ϕ}_{i , k} )$$

instead) may not result in a substantial difference in computed trajectories while resulting in a more challenging numerical resolution of the resulting information-gathering problem.

The information-gathering objective in Equation (9) guides data collection towards regions of the feature space that enable rapid adaptation. As shown in FIG. 3, the procedure of generating information gathering trajectories and adapting the model on them can be iterated as many times as needed to lower estimates of uncertainty.

Next, as to online training, which is shown in block 408 of FIG. 5, online training is performed by continuously adapting the last-layer parameters of the last-layer Bayesian meta-learning model 24 in real-time as new sensor data becomes available. Specifically, during online training, recursive Bayesian linear regression is applied to update rules to the last-layer weights of the last-layer Bayesian meta-learning model 24 using the most recent state and control input data. These updates adjust the posterior distribution over the weights based on the observed prediction errors between the model's one-step-ahead predictions and the actual vehicle state transitions. The underlying neural network feature extractor remains fixed during online training, allowing for computationally efficient updates limited to the final linear layer. This enables the vehicle dynamics model to rapidly adjust to changing conditions such as tire wear, varying road surfaces, or external disturbances, thereby improving prediction accuracy and maintaining robust control performance during operation.

FIG. 2 will now be discussed in full detail as an example environment within which the system and methods disclosed herein may operate. In one or more embodiments, the vehicle 100 is an autonomous vehicle. The vehicle 100 can include one or more processor(s) 110. In one or more arrangements, the processor(s) 110 can be a main processor of the vehicle 100. For instance, the processor(s) 110 can be an electronic control unit (ECU). The vehicle 100 can include one or more data store(s) 115 for storing one or more types of data. The data store(s) 115 can include volatile and/or non-volatile memory. Examples of data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data store(s) 115 can include map data 116. The map data 116 can include maps of one or more geographic areas. In some instances, the map data 116 can include information or data on roads, traffic control devices, road markings, structures, features, and/or landmarks in one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle map(s) 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, and hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data store(s) 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data store(s) 115 located onboard the vehicle 100. Alternatively, or in addition, at least a portion of the map data 116 and/or the sensor data 119 can be located in one or more data store(s) 115 that are located remotely from the vehicle 100.

As noted above, the vehicle 100 can include the sensor system 120. The sensor system 120 can include one or more sensors. “Sensor” means any device, component, and/or system that can detect and/or sense something. The one or more sensors can be configured to detect and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, two or more sensors can form a sensor network. The sensor system 120 and/or one or more sensors can be operatively connected to the processor(s) 110, the data store(s) 115, and/or another element of the vehicle 100 (including any of the elements shown in FIG. 2). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the vehicle 100 itself. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect and/or sense one or more characteristics of the vehicle 100. In one or more arrangements, the vehicle sensor(s) 121 can include a speedometer to determine the current speed of the vehicle 100.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, one or more environment sensors 122 can be configured to detect, quantify, and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify, and/or sense other things in the external environment of the vehicle 100, such as lane markers, signs, traffic lights, traffic signs, lane lines, crosswalks, curbs proximate the vehicle 100, off-road objects, etc.

Various examples of sensors of the sensor system 120 will be described herein. The example sensors may be part of one or more environment sensors 122 and/or one or more vehicle sensor(s) 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, one or more cameras 126 can be high dynamic range (HDR) cameras or infrared (IR) cameras.

The vehicle 100 can include an input system 130. An “input system” includes any device, component, system, element, arrangement, or groups thereof that enable information/data to be entered into a machine. The input system 130 can receive input from a vehicle passenger (e.g., a driver or a passenger). The vehicle 100 can include an output system 135. An “output system” includes any device, component, arrangement, or groups thereof that enable information/data to be presented to a vehicle passenger (e.g., a person, a vehicle passenger, etc.).

The vehicle 100 can include one or more vehicle systems 140. Various examples of one or more vehicle systems 140 are shown in FIG. 2. However, vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the vehicle control system 200, and/or the autonomous driving system 160 can be operatively connected to communicate with the vehicle systems 140 and/or individual components thereof. For example, returning to FIG. 2, the processor(s) 110 and/or the autonomous driving system 160 can be in communication to send and/or receive information from the vehicle systems 140 to control the movement, speed, maneuvering, heading, direction, etc. of the vehicle 100. The processor(s) 110, the vehicle control system 200, and/or the autonomous driving system 160 may control some or all of these vehicle systems 140 and, thus, may be partially or fully autonomous.

The processor(s) 110, the vehicle control system 200, and/or the autonomous driving system 160 can be operatively connected to communicate with the vehicle systems 140 and/or individual components thereof. For example, returning to FIG. 2, the processor(s) 110, the vehicle control system 200, and/or the autonomous driving system 160 can be in communication to send and/or receive information from the vehicle systems 140 to control the movement, speed, maneuvering, heading, direction, etc. of the vehicle 100. The processor(s) 110, the vehicle control system 200, and/or the autonomous driving system 160 may control some or all of these vehicle systems 140.

The processor(s) 110, the vehicle control system 200, and/or the autonomous driving system 160 may be operable to control the navigation and/or maneuvering of the vehicle 100 by controlling one or more of the vehicle systems 140 and/or components thereof. For instance, when operating in an autonomous mode, the processor(s) 110, the vehicle control system 200, and/or the autonomous driving system 160 can control the direction and/or speed of the vehicle 100. The processor(s) 110, the vehicle control system 200, and/or the autonomous driving system 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either directly or indirectly.

The vehicle 100 can include one or more actuator(s) 150. The actuator(s) 150 can be any element or combination of elements operable to modify, adjust, and/or alter one or more of the vehicle systems 140 or components thereof to be responsive to receiving signals or other inputs from the processor(s) 110 and/or the autonomous driving system 160. Any suitable actuator can be used. For instance, one or more actuator(s) 150 can include motors, pneumatic actuators, hydraulic pistons, relays, solenoids, and/or piezoelectric actuators, to name a few possibilities.

The vehicle 100 can include one or more modules, at least some of which are described herein. The modules can be implemented as computer-readable program code that, when executed by a processor(s) 110, implements one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store(s) 115 may contain such instructions.

In one or more arrangements, one or more of the modules described herein can include artificial or computational intelligence elements, e.g., neural networks, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include an autonomous driving system 160. The autonomous driving system 160 can be configured to receive data from the sensor system 120 and/or any other type of system capable of capturing information relating to the vehicle 100 and/or the external environment of the vehicle 100. In one or more arrangements, the autonomous driving system 160 can use such data to generate one or more driving scene models. The autonomous driving system 160 can determine the position and velocity of the vehicle 100. The autonomous driving system 160 can determine the location of obstacles, obstacles, or other environmental features, including traffic signs, trees, shrubs, neighboring vehicles, pedestrians, etc.

The autonomous driving system 160 can be configured to receive and/or determine location information for obstacles within the external environment of the vehicle 100 for use by the processor(s) 110 and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving system 160, either independently or in combination with the vehicle control system 200 can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either directly or indirectly. The autonomous driving system 160 can be configured to execute various vehicle functions and/or to transmit data to, receive data from, interact with, and/or control the vehicle 100 or one or more systems thereof (e.g., the vehicle systems 140).

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in computer-readable storage, such as a computer program product or other data programs storage device, readable by a machine, tangibly embodying a program of instructions executable by the machine to perform methods and processes described herein. These elements can also be embedded in an application product, which comprises all the features enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the foregoing specification, as indicating the scope hereof.

What is claimed is:

1. A system comprising a memory having an instruction module that includes instructions that, when executed by a processor, causes the processor to control a vehicle using a control action sequence generated by a model predictive controller that uses an enhanced predicted vehicle state based on a predicted vehicle state and a residual generated by a last-layer Bayesian meta-learning model.

2. The system of claim 1, wherein the instruction module further includes instructions that, when executed by the processor, cause the processor to determine the predicted vehicle state using a bicycle model that uses vehicle control inputs and a current vehicle state as inputs.

3. The system of claim 1, wherein the residual represents a difference between the predicted vehicle state and a true state of the vehicle.

4. The system of claim 1, wherein the last-layer Bayesian meta-learning model comprises:
shared layers; and
a last-layer that is a linear model that takes in features from the shared layers to generate the residual.

5. The system of claim 4, wherein, during an offline training, the last-layer Bayesian meta-learning model is trained by learning at least one of:
expressive neural network features through the shared layers by
using data from multiple trajectories that represent variations in dynamics of an underlying system; and
prior distributions over last-layer weights of the last-layer by simulating a process of online Bayesian linear regression across a collection of training trajectories that represent different system dynamics.

6. The system of claim 4, wherein the instruction module further includes instructions that, when executed by the processor, causes the processor to, during an online training, update last-layer weights in real time using actively gathered data to improve the accuracy of the enhanced predicted vehicle state.

7. The system of claim 1, wherein the instruction module further includes instructions that, when executed by the processor, cause the processor to generate the control action sequence by the model predictive controller using constraints including actuator limits and obstacle avoidance.

8. A method comprising controlling a vehicle using a control action sequence generated by a model predictive controller that uses an enhanced predicted vehicle state based on a predicted vehicle state and a residual generated by a last-layer Bayesian meta-learning model.

9. The method of claim 8, further comprising determining the predicted vehicle state using a bicycle model that uses vehicle control inputs and a current vehicle state as inputs.

10. The method of claim 8, wherein the residual represents a difference between the predicted vehicle state and a true state of the vehicle.

11. The method of claim 8, wherein the last-layer Bayesian meta-learning model comprises:
shared layers; and
a last-layer that is a linear model that takes in features from the shared layers to generate the residual.

12. The method of claim 11, wherein, during an offline training, the last-layer Bayesian meta-learning model is trained by learning at least one of:
expressive neural network features through the shared layers by
using data from multiple trajectories that represent variations in dynamics of an underlying system; and
prior distributions over last-layer weights of the last-layer by simulating a process of online Bayesian linear regression across a collection of training trajectories that represent different system dynamics.

13. The method of claim 11, wherein, during an online training, updating last-layer weights in real time using actively gathered data to improve the accuracy of the enhanced predicted vehicle state.

14. The method of claim 8, further comprising generating the control action sequence by the model predictive controller using constraints including actuator limits and obstacle avoidance.

15. A non-transitory computer-readable medium comprising instructions that, when executed by a processor, cause the processor to control a vehicle using a control action sequence generated by a model predictive controller that uses an enhanced predicted vehicle state based on a predicted vehicle state and a residual generated by a last-layer Bayesian meta-learning model.

16. The non-transitory computer-readable medium of claim 15, further comprising instructions that, when executed by the processor, cause the processor to determine the predicted vehicle state using a bicycle model that uses vehicle control inputs and a current vehicle state as inputs.

17. The non-transitory computer-readable medium of claim 15, wherein the residual represents a difference between the predicted vehicle state and a true state of the vehicle.

18. The non-transitory computer-readable medium of claim 15, wherein the last-layer Bayesian meta-learning model comprises:
shared layers; and
a last-layer that is a linear model that takes in features from the shared layers to generate the residual.

19. The non-transitory computer-readable medium of claim 18, wherein, during an offline training, the last-layer Bayesian meta-learning model is trained by learning at least one of:
expressive neural network features through the shared layers by
using data from multiple trajectories that represent variations in dynamics of an underlying system; and
prior distributions over last-layer weights of the last-layer by simulating a process of online Bayesian linear regression across a collection of training trajectories that represent different system dynamics.

20. The non-transitory computer-readable medium of claim 18, further comprising instructions that, when executed by the processor, cause the processor to, during an online training, update last-layer weights in real time using actively gathered data to improve an accuracy of the enhanced predicted vehicle state.
